(19) United States
(12) Patent Application Publication
(10) Pub. No.: US 2004/0233050 A1
(43) Pub. Date: Nov. 25, 2004

(54) Telemetric tire pressure monitoring system

(76) Inventor: Joerg Burghardt, Stuttgart (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/484,741

(22) PCT Filed: Jul. 31, 2002
(86) PCT No.: PCT/EP02/08528

(30) Foreign Application Priority Data
Aug. 1, 2001 (DE) 10137591.3

(51) Int. Cl. B60C 23/00

(52) U.S. Cl. 340/445

(57) ABSTRACT

The invention relates to a telemetric tire pressure monitoring system for the tire pressures at wheels of a vehicle. In this way, the driver can be warned if an excessively low tire pressure or a dangerous drop in the tire pressure occurs. According to the invention, an additional warning is issued if wheel-mounted measuring modules move away from their set point position on the respective wheel.

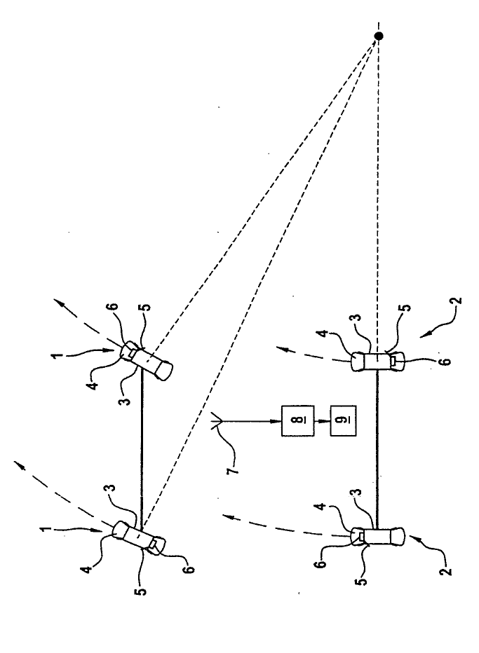

### CROSS-REFERENCE TO RELATED APPLICATION

This application claims the benefit of the filing date of International Patent Application Serial No. PCT/EP02/08528, filed on Jul. 31, 2002, which, in turn, claims the benefit of the filing date of German Patent Application, Serial No. DE 101 37 591.3, filed on Aug. 1, 2001.

### BACKGROUND AND SUMMARY OF THE INVENTION

The invention relates to a telemetric tire pressure monitoring system for the tire pressures at wheels of a vehicle, having wheel-mounted modules which each have a pressure measuring sensor, and a control unit which communicates with said modules, in particular in a wirefree fashion, in order to evaluate the sensor signals, and which generates a warning signal if the tire pressure drops below a pressure threshold value and/or a pressure loss exceeds a loss threshold value in terms of absolute value.

Series-produced motor vehicles with tire pressure monitoring systems which have essentially three components are already available on the market: wheel-mounted modules which are arranged on the air valves of the wheel rims comprise temperature and pressure measuring sensors as well as a battery-fed radio frequency transmitter, via which data telegrams relating to the pressure and temperature in the tire are emitted. These data telegrams are passed on by a radio frequency antenna via a data bus to a central control unit and are further processed there. If appropriate, warning signals are then generated, in particular if an abrupt pressure loss of more than 0.2 bar/min occurs. Furthermore, a warning signal may also be generated if the pressure drops below a pressure threshold value.

German reference DE 197 35 686 A1 relates to the assignment of the data telegrams to the individual wheels of the vehicle so that when a warning signal is generated it is also possible to indicate which vehicle wheel is affected. For this purpose there is provision for the wheel-mounted modules to be additionally equipped with a sensor system for accelerations in order, on the one hand, to be able to determine the acceleration of the wheel-mounted module in the radial direction of the wheel (centrifugal acceleration) and, on the other hand, the acceleration of the module in the circumferential direction of the wheel (acceleration along a path). By determining integrals of the centrifugal acceleration it is possible to determine the amount of travel which is covered by a wheel within a predefined time period. As the amounts of travel of the front wheels of a vehicle with steerable front wheels and (at least essentially) nonsteerable rear wheels during cornering is greater or lesser than the corresponding amounts of travel of the rear wheels, it is possible to distinguish between rear wheels and front wheels by evaluating the integrals of the centrifugal acceleration.

Furthermore, by evaluating the acceleration along a path it is possible to distinguish between the wheels of the right hand and left hand sides of the vehicle as the signals interchange their signs if a wheel is changed over from one side of the vehicle to the other side of the vehicle.

German reference DE 198 56 861 A1 (=WO 00/34062) is concerned with the assignment of the evaluated signals to the individual wheels of the vehicle. Here, reference is also made to the possibility of arranging a radio frequency antenna, which is used to receive the data telegrams of the wheel-mounted modules, on the vehicle in such a way that the signal amplitudes differ between the wheels when averaged over time. For this purpose, the antenna is arranged in such a way that it is screened differently by the wheel-mounted modules in terms of distance and strength.

The object of the invention is to be able to generate a warning signal in a tire pressure monitoring system even if a wheel-mounted module is removed from its rim-mounted set point position.

This object is achieved according to the invention by virtue of the fact that the wheel-mounted modules have a sensor system for a parameter which changes when the respective module moves out of its wheel-mounted set point position, and that the control unit converts signals which occur when there is a corresponding change in the abovementioned parameter into a (corresponding) warning signal.

The invention is based on the general idea of providing, in the wheel-mounted modules, a sensor system for parameters which change as a function of the position of the modules in the wheel, and thus when the module is removed from its set point position. At the same time, the invention ensures that the control unit is capable of “interpreting” such changes in the abovementioned parameter correctly and generating a warning signal.

In this way, allowance is made for the fact that a wheel-mounted module which moves out of the rim can carry out completely uncontrolled movements, which are potentially destructive for the tire, in the interior of the tire while the vehicle is traveling, and accordingly this highly hazardous operating state has to be detected and signaled to the driver.

The invention also takes into account the fact that parameters which are suitable for detecting whether or not a wheel-mounted module is in the set point position are also sensed, or should be sensed, for other reasons. As a result, the invention can advantageously be implemented solely by virtue of the fact that the control unit can “detect” the signal changes which are generated by the module when or after it leaves its set point position.

The centrifugal accelerations and the accelerations along a path which should be monitored in order to assign the respective modules to the vehicle wheels thus change very distinctly if the module is thrown around within the interior of the tire or dragged along at a distance from the rim on the tire.

Moreover, the temperature which is sensed by the module within the tire is also significantly dependent on the location so that detachment of the module from the rim can lead to a jump in temperature.

On the other hand, a temperature of the interior of the tire should be sensed in order to be able to sense the contribution which the heating of the air in the tire makes to the tire pressure during normal operation.

By means of corresponding signal evaluation it is therefore possible to use corresponding parameters both in the case of normal operation and in the case of hazardous system faults.

### BRIEF DESCRIPTION OF THE DRAWING

Furthermore, with respect to advantageous features of the invention, reference is made to the following explanation of the drawing by means of which a particularly preferred embodiment of the invention is explained in more detail.

Here, the single FIGURE shows a schematic illustration of a motor vehicle with tire pressure monitoring system according to the invention.

### DETAILED DESCRIPTION OF THE DRAWING

According to the drawing, the motor vehicle has steerable front wheels 1 as well as rear wheels 2 which cannot be steered in the usual way. When cornering occurs, the wheels run on curve paths of different lengths, which are illustrated by dashed lines, and when there is approximately slip-free travel they run centrally with respect to a common steering pole.

In a basically known fashion, the wheels 1 and 2 each have a rim 3 and a tire 4 which can be filled with air, or have their air pressure released, by means of a rim-mounted valve 5.

In each case a wheel-mounted module 6, which has an air pressure sensor, a temperature sensor as well as an acceleration sensor and a radio frequency transmitter, assigned to the latter, for emitting data telegrams to the respective sensor signals, is attached to the valve 5. Both the sensors and the transmitter are fed with electrical energy from a battery which is arranged in the module 6.

The abovementioned data telegrams are received in a wirefree fashion by means of at least one antenna 7 and fed to a control unit 8 which evaluates the data telegrams and at the same time can preferably also take into account further signals of a vehicle-mounted sensor system.

The control unit 8 activates a display device or signal transmitter device 9 and operates essentially as follows:

From the measurement data which is transmitted by the wheel-mounted modules 6 and relates to pressure and temperature it is possible for the control unit 8 to determine the temperature-dependent tire pressure and thus check whether it is within an acceptable range and/or whether a dangerously rapid drop in pressure is occurring. The control unit 8 accordingly activates the display or signal transmitter device 9 so that it generates a warning signal which is preferably different for different hazardous situations. For example, when there is an unacceptable drop in pressure the driver may be requested to stop, while in the case of a tire pressure in a lower tolerance range only one signal is generated, with which the driver is requested to increase the tire pressure soon.

When the abovementioned warning signals are generated, it is also possible to indicate or signal which of the vehicle wheels 1 and 2 is affected.

For this purpose, when the data telegrams relating to pressure and temperature are transmitted, the control unit 8 also receives data from the wheel-mounted modules which relate to the acceleration along a path and centrifugal acceleration determined by the respective module-mounted acceleration sensors. If the wheel-mounted modules are arranged on all the wheel rims with the same orientation, the accelerations along a path which are determined differ for wheels on different sides of the vehicle in terms of their sign, i.e. solely by evaluating the sign it is possible to distinguish between right hand and left hand wheels. Furthermore, the integrals of the centrifugal accelerations differ in terms of absolute value if the wheels 1 and 2 run on paths of different lengths during cornering. As a result, the control unit 8 can thus distinguish between the front wheels 1 and the rear wheels 2.

In addition, it is also possible to differentiate between the different wheels by corresponding positioning of the antenna 7. By shielding the antenna 7 in a way which differs in terms of the distance from the wheels 1 and 2 or which is different with respect to the radio frequency signals of the module-end transmitter it is possible to ensure that the data telegrams which are associated with different wheels 1 and 2 have different signal levels.

Finally, the control unit can additionally receive and evaluate steering wheel signals or signals from an engine control system in order to check the information determined from the data telegrams of the modules 6 for plausibility.

As a result, the control unit can therefore determine the assignment of the data telegrams to the individual wheels 1 and 2 with a high degree of reliability, and can also permit an assignment to the wheels when warning signals are generated.

A significant particular feature of the invention is that the control unit 8 can correctly evaluate “atypical” acceleration data such as inevitably occur when a wheel-mounted module 6 becomes detached from the assigned rim 3. In such a case, the detached module is moved in a way which differs significantly from the normal operation—module 6 in the set point position on the assigned rim 3- and is correspondingly accelerated in a different way. As a result, this leads to a situation in which the control unit 8 requests the driver to stop and/or to repair the respective wheel by means of the display or signal transmitter device 9.

In order to save energy, the modules 6 generally transmit data telegrams only at relatively long intervals. There is preferably then provision for the modules to carry out an internal evaluation of the data of the assigned sensors in order to be able to detect hazardous situations such as lack of tire pressure and/or insufficient pressure drop and/or detachment of the module 6 from the associated rim 3. In this case, a data telegram is generated immediately, expediently with particular characteristic data relating to the respective hazardous situation.

The detachment of a module 6 from the associated rim may be detected in a variety of ways.

For example, a detached module 6 can be detected by virtue of the fact that the acceleration signals which are transmitted to the control unit and which relate to the axes of a module 6 which point in the radial, tangential and lateral directions of the wheel when the module is in a correct position are compared with the current driving state of the vehicle. Here, each module 6 can be triggered by the control unit 8 in a selective fashion to transmit signals in order to transmit the acceleration signals. Instead, the signals which are transmitted on a regular basis can also be analyzed. Given known information about the travel speed, yaw angle rate and acceleration, acceleration and deceleration of the vehicle and/or steering angle, characteristic acceleration values are expected. In the event of deviations, it is possible to infer that the module 6 has become detached from the rim, and the control unit 8 emits a warning

In addition, or alternatively, it is also possible to detect a module 6 which has become detached from the respective rim by virtue of the fact that the acceleration signals which are transmitted to the control unit 8 and which relate to the axes of a module 6 which point in the radial, tangential and lateral directions of the wheel when the module 6 is in a correct position have to have a characteristic correlation with respect to one another. If an atypical behavior is detected in the control unit 8, it is possible to infer that a module 6 has become detached from the rim, and the control unit 8 emits a warning. Here, the module 6 can be triggered by the control unit in a selective fashion in order to transmit the acceleration signals. Instead, the signals can also be transmitted on a regular basis and analyzed by the control unit 8.

Furthermore, a module 6 which has become detached from the rim can be detected by the fact that the module 6 independently evaluates the acceleration signals relating to the axes of the module 6 which point in the radial, tangential and lateral directions of the wheel when the module 6 is in a correct position, in terms of their correlation of the individual components with respect to one another. If an atypical behavior which deviates from normal characteristic correlations is detected here, it is possible to infer that a module 6 has become loose, and the module 6 independently emits corresponding signals to the control unit 8 which can then output a warning to the driver.

A loose module 6 can also be detected if the acceleration signals which are transmitted to the control unit 8 and which relate to the radial, tangential and lateral directions of all the modules 6 on the vehicle are transmitted at least virtually simultaneously and evaluated and compared with one another. A loose module 6 will indicate here a signal pattern which deviates significantly from the other modules 6, and can thus be detected. Here, all the modules 6 should be triggered within a short time window in order to receive the acceleration signal combination from all the modules 6 in the same driving state.

Finally, a loose module 6 can be detected by virtue of the fact that the temperature values of all the modules 6 on the vehicle which are transmitted to the control unit are evaluated in the control unit 8 and compared with one another. A loose module 6 will output temperature signals which differ significantly from the other modules 6 in such a context, and can thus be detected.

1. (Cancelled)

2. (Cancelled)

3. (Cancelled)

4. (Cancelled)

5. (Cancelled)

6. (Cancelled)

7. (Cancelled)

8. (Cancelled)

9. (Cancelled)

10. A telemetric tire pressure monitoring system for the tire pressures of wheels of a vehicle comprising wheel-mounted modules which each have a pressure measuring sensor, and a control unit which communicates with said wheel-mounted modules, by way of a wireless medium, in order to evaluate the sensor signals and which generates a warning signal if the tire pressure drops below a pressure threshold value and/or a pressure loss exceeds a loss threshold value, wherein the wheel-mounted modules have a sensor system for a parameter which changes when the respective module moves out of its wheel-mounted set point position, and in that the control unit converts signals which occur when there is a corresponding change in the parameter, into a warning signal.

11. The telemetric tire pressure monitoring system for the tire pressures of wheels of a vehicle, having wheel-mounted modules which each have a pressure measuring sensor and an acceleration sensor, and a control unit which communicates with said wheel-mounted modules by way of a wireless medium, in order to evaluate the sensor signals and which generates a warning signal if the tire pressure drops below a pressure threshold value, and/or a pressure loss drops below a loss threshold value in terms of absolute value, the control unit evaluating the acceleration signals, if appropriate together with signals of a further sensor system, in order to differentiate or sense different wheels, wherein the control unit converts a change in the acceleration signals which occurs when a module moves out of its wheel-mounted set point position, into a warning signal.

12. The tire pressure monitoring system as claimed in claim 10, wherein the warning signal for module not in set point position is different from the warning signal or the warning signals for the case in which the pressure drops below the pressure threshold value or the case in which the pressure loss exceeds the threshold value.

13. The tire pressure monitoring system as claimed in claim 10, wherein the modules which communicate with the control unit only at relatively long time intervals during normal operation have an internal evaluation of the sensor signals, and enter into communication immediately with the control unit when a hazardous situation is detected.

14. The tire pressure monitoring system as claimed in claim 10, wherein the control unit receives information about vehicle state parameters from a sensor system and determines from said information acceleration signals which are to be expected from the modules and which, given a correct position of the modules fixed to the wheels, represent the accelerations of said modules in the radial, lateral and/or tangential direction of the wheel, and compares them with the signals which are actually output by the modules, a warning signal being generated when there is a deviation which exceeds a tolerance range.

15. The tire pressure monitoring system as claimed in claim 10, wherein the control unit checks acceleration signals which are transmitted by the modules and which, given a correct position of the modules fixed to the wheels, represent the accelerations in the radial, lateral and/or tangential direction of the wheel, for characteristic correlations between the acceleration components, and generates a warning signal when there is a deviation which exceeds a tolerance range.

16. The tire pressure monitoring system as claimed in claim 10, wherein each module checks acceleration signals which are supplied by its sensor system and which, given a correct position of the modules fixed to the wheels, represent their acceleration in the radial, lateral and/or tangential direction of the wheel, for characteristic correlations between the acceleration components, and when there is a deviation which exceeds a tolerance range each module transmits a corresponding signal to the control unit which then generates a warning signal.

17. The tire pressure monitoring system as claimed in claim 10, wherein the control unit calls or receives, at least virtually simultaneously from all the modules, acceleration signals which, given a correct position of the modules fixed to the wheels, represent their acceleration in the radial, lateral and/or tangential direction of the wheel, and said control device generates a warning signal if one of the modules transmits signals which deviate excessively from the signals of the other modules.

18. The tire pressure monitoring system as claimed in claim 10, wherein the modules have temperature sensors and the control unit generates a warning signal if a module signals a temperature which deviates excessively from the other, signaled temperatures.

19. A system comprising:
a wheel-mounted module to generate a signal related to a characteristic of a corresponding tire of a vehicle; and
a control unit to determine whether said wheel-mounted module is properly mounted to said tire by analysis of said signal generated by said wheel-mounted module.

20. The system of claim 19, wherein said signal relates to a pressure of said tire.

21. The system of claim 19, wherein said signal relates to a temperature of said tire.

22. The system of claim 19, wherein said signal relates to a radial acceleration of said tire.

23. The system of claim 19, wherein said signal relates to a lateral acceleration of said tire.

24. The system of claim 19, wherein said signal relates to a tangential acceleration of said tire.

25. The system of claim 20, wherein said wheel-mounted module further comprises a pressure sensor for sensing said pressure of said tire.

26. The system of claim 20, wherein said control unit generates a warning signal if said pressure signal indicates that said pressure of said tire is below a pressure threshold value.

27. The system of claim 20, wherein said control unit generates a warning signal if said pressure signal indicates that a loss of said pressure of said tire exceeds a loss threshold value.

28. The system of claim 21, wherein said wheel-mounted module further comprises a temperature sensor for sensing said temperature of said tire.

29. The system of claim 21, wherein said control unit generates a warning signal if said temperature signal is substantially different than a second temperature signal generated by a second wheel-mounted module mounted to a second tire.

30. The system of claim 19, wherein said signal relates to a radial, lateral and/or tangential acceleration of said tire, and said control unit generates a warning signal if said signal deviates more than a tolerance range.

31. The system of claim 19, wherein said signal relates to a radial lateral and/or tangential acceleration of said tire, and said control unit generates a warning signal if said signal is substantially different than a second signal generated by a second wheel-mounted module mounted to a second tire.

32. The system of claim 19, wherein said wheel-mounted module comprises a transmitter for transmitting said signal to said control unit by way of a wireless medium.

33. A method comprising:
generating a signal related to a characteristic of a corresponding tire of a vehicle; and
determining whether said wheel-mounted module is properly mounted to said tire by analysis of said signal.
